(19) United States
(12) Patent Application Publication
(10) Pub. No.: US 2015/0082800 A1
(43) Pub. Date: Mar. 26, 2015

(54) METHOD FOR SUPPRESSING GENERATION OF YELLOW PLUM OF COMPLEX THERMAL POWER PLANT USING HIGH THERMAL CAPACITY GAS

(71) Applicant: Korea Electric Power Corporation, Seoul (KR)

(72) Inventors: Se Ik PARK, Daejeon (KR); Jin Pyo HONG, Seoul (KR); Sung Chul KIM, Daejeon (KR); Kwang Beom HUR, Daejeon (KR); Joong Won LEE, Daejeon (KR); Kyung Ho KO, Daejeon (KR)

(73) Assignee: KOREA ELECTRIC POWER CORPORATION, Seoul (KR)

(21) Appl. No.: 14/036,931

(22) Filed: Sep. 25, 2013

(51) Int. Cl. F02C 3/22; F02C 3/34

(52) U.S. Cl. CPC F02C 3/22; F02C 3/34
USPC 60/776

(57) ABSTRACT

There is provided a method for suppressing a generation of a yellow plume from a complex thermal power plant, the method being characterized in that, in a complex thermal power generating method including combusting fuel and compressed air for combustion, supplied to a combustor, to generate exhaust gas; generating power using the exhaust gas generated in the combusting; recovering heat of the exhaust gas by a heat recovery steam generator (HRSG) and generating power using the recovered heat and a steam turbine, and controlling an amount of supplied high thermal capacity gas supplying the high thermal capacity gas together with the fuel in the combusting, in such a manner that nitrogen dioxide is contained in the exhaust gas in an amount of 10 ppm or less (based on exhaust gas containing an oxygen concentration of 15%).

### BACKGROUND

1. Technical Field

The present disclosure relates to a method for suppressing a generation of a yellow plume from a complex thermal power plant using high thermal capacity gas.

2. Description of the Related Art

Gas turbines for power generation may discharge a small amount of exhaust gas such as unburned hydrocarbons (HC), soot, or nitrogen dioxide (NO₂) due to a combustion phenomenon, and among these, nitrogen dioxide (NO₂) is known as being a generative source of yellow plumes discharged through chimneys. An amount of yellow plumes generated may be low in a base load, and accordingly, the identification thereof may be difficult, but the amount of the yellow plumes generated may be high in a partial load and thus, it may become a target of public grievance for local residents. In particular, since complex thermal power plants aiming for natural gas may be easily started and stopped, as compared to general coal-fired power plants, a load variation operation frequently occurs, depending on a power supply state rather than in the base load, whereby the removal of a yellow plume and the suppression of the generation thereof has become an important issue.

In existing complex thermal power plants, in order to remove a yellow plume generated in the case of a partial load operation according to the request of power grid, a reducing agent such as ethanol may be jetted into an exhaust portion having been passed through a heat recovery steam generator (HRSG) to thereby remove the yellow plume. However, such a processing method may have limitations such as relatively high costs for the construction of an injecting device for a reducing agent at the initial stage and a yearly cost of several hundred million to one billion Korean won for the purchasing of the reducing agent.

### SUMMARY

An aspect of the present disclosure provides an environmentally friendly and economical method for suppressing a generation of a yellow plume from a complex thermal power plant, capable of effectively removing the yellow plume generated at a partial load, using high thermal capacity gas.

According to an aspect of the present disclosure, there is provided a method for suppressing a generation of a yellow plume from a complex thermal power plant, the method being characterized in that in a complex thermal power generating method including combusting fuel and compressed air for combustion, supplied to a combustor, to generate exhaust gas; generating power using the exhaust gas generated in the combusting; and recovering heat of the exhaust gas by a heat recovery steam generator (HRSG) and generating power using the recovered heat and a steam turbine, high thermal capacity gas as well as the fuel are supplied in the combusting to reduce a local high temperature generating portion inside flames, thereby suppressing a generation of nitrogen dioxide.

The high thermal capacity gas may be a carbon dioxide-containing gas.

The carbon dioxide-containing gas maybe biogas or land fill gas (LFG).

A volume ratio of the high thermal capacity gas to the fuel supplied to the combustor may be 8 to 10:1.

The method for suppressing a generation of a yellow plume from a complex thermal power plant may further include controlling an amount of the supplied high thermal capacity gas in such a manner that the nitrogen dioxide is contained in the exhaust gas in an amount of 10 ppm or less (based on exhaust gas containing an oxygen concentration of 15%).

In the controlling, a turbine inlet temperature may be measured, and the amount of the supplied high thermal capacity gas may be controlled such that a decrease rate of the turbine inlet temperature is 10% or less.

In the controlling, a combustor dynamic pressure signal may be measured, and the amount of the supplied high thermal capacity gas may be controlled such that an increase rate of the combustor dynamic pressure signal is 20% or less.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram schematically illustrating a method for suppressing a generation of a yellow plume using high thermal capacity gas according to an exemplary embodiment of the present disclosure, in the case of a partial load.

FIG. 2 is a diagram schematically illustrating the method for suppressing a generation of a yellow plume according to the exemplary embodiment of the present disclosure, including a control process of controlling an input amount of high thermal capacity gas.

FIG. 3A and FIG. 3B are graphs respectively illustrating amounts of NOₓ and NO₂ discharged in a combustion experiment using a gas turbine combustor, by the method for suppressing a generation of a yellow plume according to the exemplary embodiment of the present disclosure.

### DETAILED DESCRIPTION OF THE EXEMPLARY EMBODIMENTS

Hereinafter, exemplary embodiments of the present disclosure will be described in detail with reference to the accompanying drawings. The inventive concept of the present disclosure may, however, be embodied in many different forms and should not be construed as being limited to the exemplary embodiments set forth herein. Rather, these exemplary embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

An exemplary embodiment of the present disclosure relates to a method for suppressing a generation of a yellow plume from a complex thermal power plant, the method capable of suppressing a generation of nitrogen dioxide by reducing a local high temperature generating portion inside flames in a combustor through supplying high thermal capacity gas to a gas turbine. According to exemplary embodiments of the present disclosure, the generation of nitrogen dioxide causing a yellow plume may be inhibited to thereby further effectively remove the yellow plume, as compared to the related art method of removing the yellow plume by jetting a reducing agent such as ethanol into an exhaust portion. In addition, in exemplary embodiments of the present disclosure, since biogas maybe used as the high thermal capacity gas, the embodiments of the present disclosure may be eco-friendly and further, a cost required for an injection device for a reducing agent and a purchasing cost of the reducing agent may be reduced, the embodiments of the present disclosure may also be useful in terms of economical aspects.

According to an exemplary embodiment of the present disclosure, in a complex thermal power generating method including: combusting fuel and compressed air for combustion, supplied to a combustor, to generate exhaust gas; generating power using the exhaust gas generated in the combusting; and recovering heat of the exhaust gas by a heat recovery steam generator (HRSG) and generating power using the recovered heat and a steam turbine, the method for suppressing a generation of a yellow plume from a complex thermal power plant, capable of suppressing a generation of nitrogen dioxide by supplying high thermal capacity gas together with the fuel in the combusting process to reduce a local high temperature generating portion inside flames may be provided.

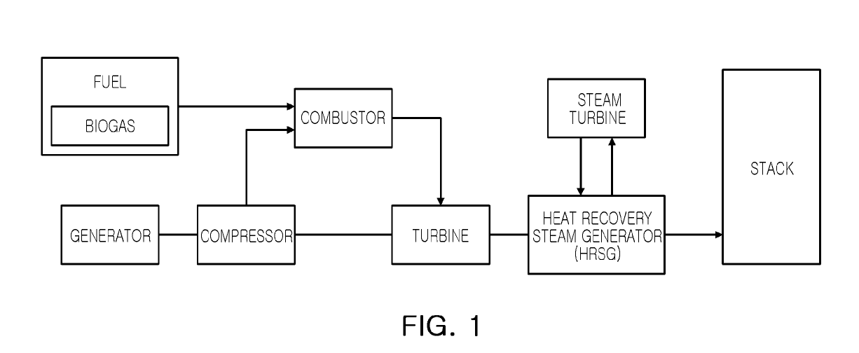

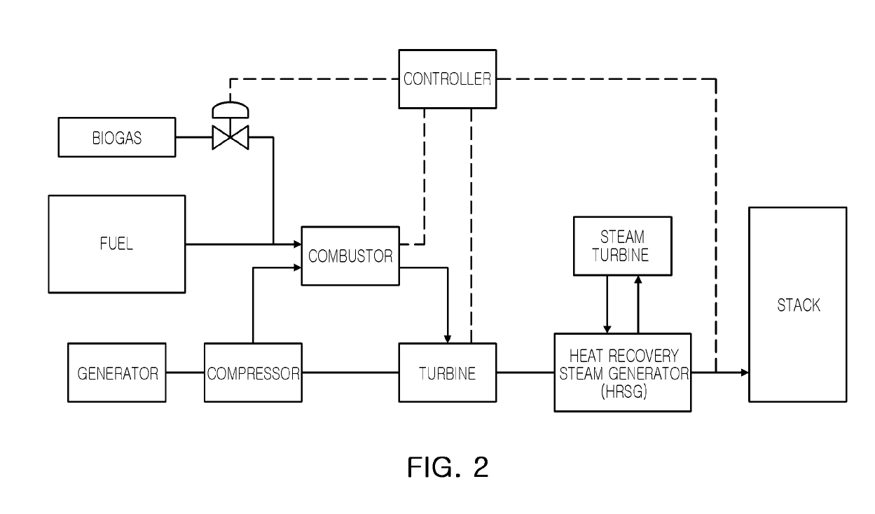

FIG. 1 is a diagram schematically illustrating a method for suppressing a generation of a yellow plume using high thermal capacity gas according to an exemplary embodiment of the present disclosure, in the case of a partial load. FIG. 2 is a diagram schematically illustrating the method for suppressing a generation of a yellow plume according to the exemplary embodiment of the present disclosure, including a control process of controlling an input amount of high thermal capacity gas.

The complex thermal power generating method may be performed using a gas turbine, a heat recovery steam generator (HRSG), and a steam turbine. The gas turbine may be configured of a compressor, a combustor, and a turbine unit. Air used in combustion may be compressed in the compressor. The fuel and air for combustion compressed in the compressing process may be supplied to the combustor and combusted therein to thereby generate exhaust gas. The generating of power using the exhaust gas generated in the combusting process may be performed in the turbine unit. The recovering of heat and the generating of power may be performed by recovering heat of the exhaust gas discharged from the turbine through the heat recovery steam generator (HRSG) and generating power using the recovered heat and the steam turbine.

Natural gas including CO, H₂CH₄, NH₃, and the like, as well as coal gas, may be input as fuel to the gas turbine of the complex thermal power plant, and air (N₂ and O₂) for combustion together with the fuel may be input to the gas turbine and combusted therein. The fuel or air may include nitrogen, and in a case in which a combustion temperature in the gas turbine is about 1200° C. or more, the nitrogen in the air may react with oxygen to generate nitrogen oxide during a high temperature oxidation reaction. In the nitrogen oxide, nitrogen dioxide may be observed as yellow plumes when being discharged through chimneys to the atmosphere.

When the high thermal capacity gas and the fuel are supplied to the combustor, such that a temperature of a local high temperature portion inside flames is controlled to be equal to or less than a NOx generation temperature, an amount of nitrogen oxide generated may be reduced, thereby consequently suppressing yellow plumes from occurring. The high thermal capacity gas and the fuel may be input together to the combustor to absorb calories generated during the combusting process, thereby serving to lower the combustion temperature.

The high thermal capacity gas is not particularly limited, but may be a carbon dioxide-containing gas. The carbon dioxide-containing gas is not particularly limited, but may be biogas or land fill gas (LFG). The biogas or land fill gas (LFG), gas having a ratio of methane to carbon dioxide in a range of about 6:4, may be mixed with the fuel, such that carbon dioxide, the high thermal capacity gas, may be supplied to the gas turbine to thereby control the combustion temperature.

A volume ratio of the high thermal capacity gas to the fuel supplied to the combustor may be 8 to 10:1. In the case that the volume ratio is less than 8:1, an output of the gas turbine may be degraded due to the lowering in the combustion temperature. When the volume ratio is greater than 10:1, an effect of reducing the generation of nitride oxides may be insignificant.

The method for suppressing the generation of the yellow plume from the complex thermal power plant may further include controlling an amount of the supplied high thermal capacity gas such that nitrogen dioxide is contained in the exhaust gas in an amount of 10 ppm or less (based on exhaust gas containing an oxygen concentration of 15%), in the combusting process. When nitrogen dioxide is contained in the exhaust gas in an amount greater than 10 ppm, yellow plumes discharged from chimneys may be macroscopically observed. Thus, in a case in which nitrogen dioxide is contained in the exhaust gas in an amount greater than 10 ppm, a controller may transmit a signal to the combusting process to increase the amount of the supplied high thermal capacity gas, thereby controlling the amount of nitrogen dioxide contained in the exhaust gas to be less than 10 ppm.

In the controlling process, a turbine inlet temperature may be measured, and the amount of the supplied high thermal capacity gas may be controlled such that a decrease rate of the turbine inlet temperature is 10% or less. When the decrease rate of the turbine inlet temperature is greater than 10%, based on an average temperature thereof under the corresponding load condition, an excessive amount of high thermal capacity gas may be supplied and an output efficiency of the gas turbine may be decreased below a level required for power generation.

Further, in the controlling process, a combustor dynamic pressure signal may be measured, and the amount of the supplied high thermal capacity gas may be controlled such that an increase rate of the combustor dynamic pressure signal is 20% or less. When the increase rate of the combustor dynamic pressure signal is greater than 20%, based on an average ratio thereof under the corresponding load condition, an excessive amount of high thermal capacity gas may be supplied and unstable pressure waves may be generated in the combustor, such that substances present in the combustor may be damaged.

Hereinafter, exemplary embodiments of the present disclosure will be described in detail through concrete examples. The examples may be merely provided by way of example for facilitating an understanding of the present disclosure, and the scope of the present disclosure is not limited thereto.

### EXAMPLE 1

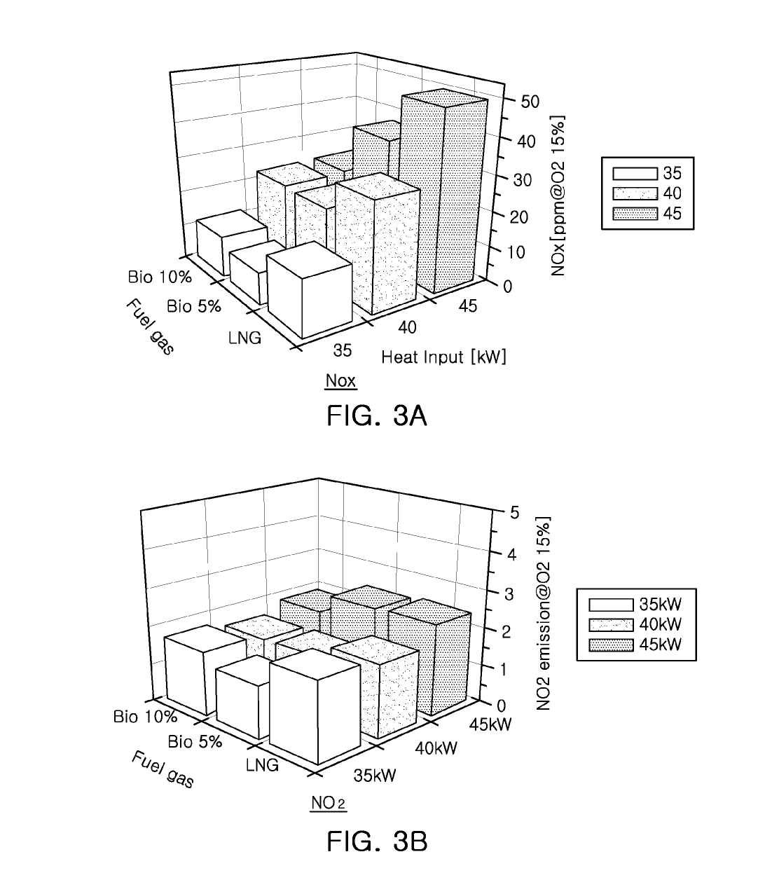

Liquefied natural gas (LNG), including 5% of biogas, was supplied to a gas turbine and a load condition was set such that calories of supplied fuel were 35 kW, 40 kW and 45 kW, respectively, to perform combustion tests. In order to quantitatively compare amounts of exhaust gas generated when the composition of the supplied fuel was varied, amounts of generated nitride oxide (NOx) and nitrogen dioxide (NO₂) are respectively illustrated in FIG. 3A and FIG. 3B, based on exhaust gas containing an oxygen concentration of 15% as a standard.

### EXAMPLE 2

With the exception that LNG included 10% of biogas, the tests were performed under the same conditions as those of Example 1 and the amounts of generated nitride oxide (NOx) and nitrogen dioxide (NO₂) were respectively measured and illustrated in FIG. 3A and FIG. 3B.

### COMPARATIVE EXAMPLE 1

With the exception that LNG did not include biogas, the tests were performed under the same conditions as those of Example 1 and the amounts of generated nitride oxide (NOx) and nitrogen dioxide (NO₂) were respectively measured and illustrated in FIG. 3A and FIG. 3B.

As can be seen in FIG. 3A and FIG. 3B, it could be confirmed that the amounts of generated nitride oxide (NOx) and nitrogen dioxide (NO₂) were reduced in Example 1 and Example 2 including biogas mixed therein by 40% or more and 10% or more, respectively, as compared to Comparative Example 1.

In addition, it could be confirmed that as a load condition was increased, the amount of nitride oxide generated in the gas turbine was correspondingly increased, and an amount of nitride oxide reduced due to the mixture of biogas was also increased. It could be confirmed that as the load condition was increased by increasing the amount of supplied fuel, while an amount of air supplied was constant, the combustion temperature was higher to thereby increase the amount of generated nitride oxide, and that as the load condition was higher, effects of reducing the generation of nitride oxide were increased by allowing the high thermal capacity gas to reduce a local high temperature portion generated during a combustion reaction at a higher rate.

As set forth above, the method for suppressing the generation of the yellow plume from the complex thermal power plant according to exemplary embodiments of the present disclosure may be used, whereby the yellow plume generated in the case of a partial load may be effectively removed, and environmentally friendly and economical aspects may be improved.

While the present disclosure has been shown and described in connection with the exemplary embodiments, it will be apparent to those skilled in the art that modifications and variations can be made without departing from the spirit and scope of the present disclosure as defined by the appended claims.

What is claimed is:

1. A method for suppressing a generation of a yellow plume from a complex thermal power plant, the method being characterized in that in a complex thermal power generating method including combusting fuel and compressed air for combustion, supplied to a combustor, to generate exhaust gas; generating power using the exhaust gas in the combusting; recovering heat of the exhaust gas by a heat recovery steam generator (HRSG) and generating power using the recovered heat and a steam turbine, and controlling an amount of supplied high thermal capacity gas supplying the high thermal capacity gas together with the fuel in the combusting, in such a manner that nitrogen dioxide is contained in the exhaust gas in an amount of 10 ppm or less (based on exhaust gas containing an oxygen concentration of 15%).

2. The method of claim 1, wherein the high thermal capacity gas is a carbon dioxide-containing gas.

3. The method of claim 2, wherein the carbon dioxide-containing gas contains methane and carbon dioxide.

4. The method of claim 3, wherein the carbon dioxide-containing gas is biogas or land fill gas (LFG).

5. The method of claim 4, wherein the biogas or landfill gas (LFG) has a volume ratio of methane to carbon dioxide in a range of 6:4.

6. The method of claim 1, wherein a volume ratio of the high thermal capacity gas to the fuel supplied to the combustor is 8 to 10:1

8. The method of claim 1, wherein in the controlling, a turbine inlet temperature is measured, and the amount of the supplied high thermal capacity gas is controlled such that a decrease rate of the turbine inlet temperature is 10% or less.

9. The method of claim 1, wherein in the controlling, a combustor dynamic pressure signal is measured, and the amount of the supplied high thermal capacity gas is controlled such that an increase rate of the combustor dynamic pressure signal is 20% or less.
